(19) United States
(12) Patent Application Publication
(10) Pub. No.: US 2006/0244718 A1
(43) Pub. Date: Nov. 2, 2006

(54) Robust position detection for a multi-stroke electronic brush display

(75) Inventors: Martin G. H. Hiddink, Eindhoven (NL); Anthonie H. Bergman, Eindhoven (NL); Hurbertus M. R. Costenraad, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/565,659

(22) PCT Filed: Jul. 21, 2004
(86) PCT No.: PCT/IB04/51277

§ 371 Date: Jan. 23, 2006

Related U.S. Application Data
(60) Provisional application No. 60/489,607, filed on Jul. 24, 2003.

(51) Int. Cl. G09G 5/00

(52) U.S. Cl. 345/156

(57) ABSTRACT

The invention provides a method of activating an electronic paint (50). A registration code embedded in a first portion (20) of an image written on a portion of an electronic paint (50) is scanned. A position of an electronic brush (30) is determined based on the scanned registration code, and a second portion (22) of the image is written on the electronic paint (50) based on the determined position of the electronic brush (30).

This invention relates generally to electronic-paint activation, and more specifically to a method and system for writing an image onto an electronic paint with an electronic brush.

Micro-encapsulated electrophoretic (MEP) materials, which have been introduced into screens and displays of personal digital assistants (PDAs), mobile phones, electronic-mail devices, and electronic readers, exhibit high optical reflectance and contrast, a wide viewing angle, high resolution, and image stability. Because MEP materials can be printed on large, flexible plastic sheets and laminated to a variety of electronic backplanes, MEP displays are being developed for flat-panel computer monitors, whiteboards, and billboards. Researchers are working on integrating MEP materials with flexible transistor technologies to produce high-resolution, low-power displays for large signage as well as smaller applications that have the look and form of a printed page. MEP displays are attractive because they can be more than six times brighter than reflective liquid-crystal displays (LCDs) and can be seen at any angle without a change in contrast, unlike LCDs.

The MEP material is used as a type of electronic ink, also referred to as digital ink, which when activated embodies a desired image on the MEP surface. Electrophoretic displays can be bistable, in that their display elements have first and second display states that differ in at least one optical property such as lightness or darkness of a color. In recent electrophoretic displays, changes in the display occur after microencapsulated particles in the electronic ink have been driven to one state or another by means of an electronic pulse of a finite duration, and the last display state persists after the voltage has been removed. Such displays have attributes of good brightness and contrast, wide viewing angles, state bi-stability, and low power consumption when compared with liquid crystal displays (LCDs).

The surface of an exemplary display comprises a thin electrophoretic film with millions of tiny microcapsules in which positively charged white particles and negatively charged black particles are suspended in a clear fluid. When a negative electric field is applied to the display, the white particles move to the top of the microcapsule where they become visible to the user. This makes the surface appear white at the top position or surface of the microcapsule. At the same time, the electric field pulls the black particles to the bottom of the microcapsules where they are hidden. When the process is reversed, the black particles appear at the top of the microcapsule, which makes the surface appear dark at the surface of the microcapsule. When the activation voltage is removed, a fixed image remains on the display surface. Before another image is written, the so-called electronic ink of the display material may need to be reset to a well-defined state, such as an all white surface with white particles moved to the top of the microcapsules, prior to re-addressing the ink. This can be accomplished by, for example, applying a relatively high voltage across front and rear electrodes of the display, forcing the ink into one state through the applied electric field. In other types of electrophoretic displays, a photoconductive layer sandwiched with the encapsulated electrophoretic materials between the front and rear electrodes is irradiated while an activation voltage is applied. Gates and others describe addressing schemes for controlling such bistable electronically addressable displays in “Methods for Addressing Electrophoretic Displays”, Gates, U.S. Pat. No. 6,531,997 issued Mar. 11, 2003.

Another addressing system for imaging on MEP material uses high-resolution laser printing mechanisms, as disclosed in “Methods and Apparatus for Imaging Electronic Paper”, Michaelis, U.S. Patent Application 2002/0057250 published May 16, 2002. The electronic paper of the system comprises a photoconductive layer of selenium, cadmium sulfide, photoconductive silicon, or any organic photoconductor, which is selectively illuminated by a focused light source, thereby exposing selected electrostatic display cells to the electrical potential and writing an image onto the electronic paper.

Digital or electronic ink technology has the potential to be extended to a large electronic wall display. Thin, flexible MEP film is attractive for placing on a large vertical surface as a so-called electronic wallpaper, poster or wall screen when semi-permanent images are desired. Appropriate applications include large electronic advertisements and home wall displays of the latest shopping list, vacation pictures, or family pictures.

When used in large display applications, a large electrophoretic display may need to be updated only infrequently, with days or even weeks or months between updates. As a result, most electronic-ink systems for large electrophoretic displays have no intrinsic addressing schemes, such as fixed coordinates on a pixel-by-pixel grid, to accurately write text and graphics. In contrast, most currently available electrophoretic displays receive data and are addressed by driving an active matrix of the display. Active-matrix driving, however, is not an attractive option for inexpensive billboard-like displays, which require only a low to extremely low refresh rate.

A majority of the methods, systems and related devices for addressing and controlling electronic-ink displays have focused on transferring input data from the surface of the display to computer usable media and then writing to the active matrix display, rather than from transferring the computer-usable media to the display surface. Exemplary handheld personal computers, PDAs or web-enabled mobile phones generate data by a user writing and drawing on a touch-sensitive screen of the device, or on a writing tablet with a stylus or other pointing device. Current digital-ink technology can extract information from the handwriting, including the contact pressure, vector, timing, coordinates, and angle of the stylus on the writing surface.

A few systems such as touch-screen computer screens display images as well as accept input from the display surface. One example that uses a switching mechanism to toggle between a display mode and a writing mode is described in “Optical Write Apparatus and Optical Write Method”, Koshimizu et al., U.S. Patent Application 2002/0118400, published Aug. 29, 2002. After the screen has been switched to the writing mode, data can be input to a computer controller with the optical writing apparatus applying light upon a selected point of the display to input image data.

An exemplary method for addressing an active matrix of an electrophoretic display uses a non-conductive brush, as described in “Methods for Addressing Electro-Optic Materials”, Goenaga et al., U.S. Patent Application 2003/0053189 published Mar. 20, 2003. The method detects a potential difference between the moistened, non-conductive brush and the display. The electrically charged fluid from the pen carries an electronic charge onto the electro-optic material of the display, thereby causing dark particles in the electrophoretic fluid of microscapsules to the top or surface of the microcapsules, which appear as a dark electronic ink contrasted against the light background of the display fluid or light-colored particles.

Systems have been developed to detect the position of and control input devices for electrophoretic as well as other type of displays. Relative positioning systems have been created to detect the motion of a pen on a writing surface, as described in “Electronic Module for Sensing Pen Motion”, U.S. Patent Application 2002/0181744, Vablais et al., Dec. 5, 2002. An electronic module is preferably mounted in a substitute ink cartridge and includes an accelerometer for detecting pen motion. Ballistic information generated by the accelerometer is transmitted via the radio transmitter to a computer where it can be processed for handwriting recognition and activating digital-ink.

An electrophoretic display with an erasable drawing device is disclosed in “Microencapsulated Electrophoretic Electrostatically-Addressed Media for Drawing Device Applications”, Comiskey et al., U.S. Pat. No. 6,473,072 issued Oct. 29, 2002. The display includes an encapsulated electrophoretic display media, a rear electrode, and a movable electrode for writing or erasing. The encapsulated display media comprises a plurality of capsules, each capsule comprising a plurality of particles dispersed in a fluid. An electric field is applied across the display media between the rear electrode adjacent the rear surface of the display media and the movable electrode, which can be in the form of a marker or an eraser and is positioned adjacent the frontward surface.

A method for electronically addressing small electronic-ink displays is described in “Transducer and Indicators having Printed Displays”, Albert et al., International Patent WO9910769 and U.S. Pat. No. 6,118,426, both granted Sep. 12, 2000. Suggested applications for these displays include small stickers placed on consumer goods like fruit, milk, or batteries, which could be used as freshness indicators by changing the state of the displays after a certain time has elapsed. Other applications include those where it is useful to provide intermittent updates, or when a certain pressure, thermal, radiative, moisture, acoustic, inclination, pH, or other threshold is passed at the position of the display. The display system may use radio frequencies to power, address and control the display, and include one or more antennae, passive charging circuitry, an active control system, a display, and an energy storage unit. A separate transmitter provides remote power for the display. A tile-based display allowing a modular system for large printable area has been suggested with traces disposed on a substrate.

Another application for small MEP displays has been developed for re-writable barcode displays, as described in “Sheet or the Like Having Rewritable Barcode Displaying Part”, Endo, JP2002/140659 issued May 17, 2002. The sheet with the barcode has a bi-stable microcapsule layer on which a barcode image can be written and controlled by applying voltage to the microcapsule layer.

An example of a more complex MEP display is described in “Illumination System for Nonemissive Electronic Displays”, Comiskey, WO0020923 published Apr. 13, 2000. Individual display elements are tiled to create a multi-piece, selectively illuminated, three-dimensional display structure. The display may be updated using visible light or other forms of electromagnetic radiation.

While addressing systems that are designed for smaller electrophoretic displays can be used for larger displays, using active-matrix driving systems may not be cost effective for larger applications. When the alternative passive-matrix activation is employed, large electrophoretic displays have additional alignment and addressing issues with transferring data such as images or text during multiple strokes of a writing device on a variably sized display surface such as on a wall. In one approach that uses a handheld device, a voltage is applied across the front and back electrodes of an electrophoretic display, and a handheld laser scanner locally changes the conductivity of a photoconductor sandwiched between the electrodes, thereby causing the encapsulated electrophoretic material to change state as desired.

For example, larger systems that use tiled arrays of displays need to avoid gaps and dead-band regions while retaining constant magnification across adjacent tiles. In other types of wall-display technologies such as light-projection systems, methods of processing, sectionalizing and transferring a large display of data onto a wall have been developed. A large projected display has been created with multiple display devices, a screen, and multiple lens assemblies, as described in “Seamless Tiled Display System”, Dubin et al., U.S. Patent Application 2002/0080302 published Jun. 27, 2002. A scalable seamless tiled display is subdivided into multiple sections, and each section is configured to display a sectional image. One of the lens assemblies is optically coupled to each of the sections of each of the display devices to project the sectional image displayed on that section onto the screen.

While the aforementioned active matrix addressing systems may be feasible for small and large expensive applications, an activation system without an active matrix-addressing scheme is desirable for large, inexpensive wall or signage displays. Any type of addressing device for electronic ink needs to be able to write to or activate the electronic ink. The system of the addressing device should be able to store the image or text being conveyed to the display. The device should be equipped to identify or sense the position the device, and to detect the location of the device in relation to the display surface.

Transferring data such as a large picture or image to passive electrophoretic material on a wall requires a method for aligning strokes of a handheld device when multiple strokes over the wall are needed. For example, a one-meter by one-meter display may require at least five different strokes of a handheld device that has a 20-centimeter long addressing mechanism, in much the same way that any wall being painted requires multiple strokes with a paint roller. Generating large images with electronic ink requires a process whereby the position of the input device can be determined accurately and multiple strokes over the surface of the electronic ink do not cause alignment artifacts of the device.

Systems in electronic display technologies other than those using electrophoretic materials have been developed to sense or track handheld devices and minimize or eliminate overlap effects. Exemplary handheld laser scanners can measure three-dimensional surfaces as they move or sweep smoothly near an object and send data to a computer. A computer application converts measurement data into computer generated images, with the finished scan combining overlapping sweeps to develop surface models of non-metal objects.

In light of the discussion above, there is a need for an effective, relatively inexpensive system and electronic device to control and transfer data to the surface of a large electrophoretic wall display without alignment and problems typically associated with multiple strokes of a writing device. Therefore, it is the intent of this invention to provide a system, method, and associated electronic activation device to control and transfer digital data to an electrophoretic display; to electronically generate a picture without alignment artifacts of a device; to provide a method for writing onto types of electrophoretic displays that require being reset to a white or black condition prior to writing; and to overcome the challenges and obstacles described above.

One aspect of the invention is a method of activating an electronic paint. A registration code is scanned, the registration code being embedded in a first portion of an image that is written on a portion of an electronic paint. A position of an electronic brush is determined based on the scanned registration code, and a second portion of the image is written on the electronic paint based on the determined position of the electronic brush.

Another aspect of the invention is a system for activating an electronic paint. The electronic-paint activation system includes an electronic brush with an electronic-paint activation device; an electronic-brush scanner coupled to the electronic brush; and a controller in electrical communication with the electronic-paint activation device and the electronic-brush scanner. A position of the electronic brush is determined based on a registration code embedded in a first portion of an image written on a portion of an electronic paint that is scanned by the electronic-brush scanner and communicated to the controller. An electronic-paint write signal is sent from the controller to the electronic-paint activation device based on the determined electronic-brush position.

Another aspect of the invention is an electronic brush for activating an electronic paint. The electronic brush includes an electronic-brush housing, an electronic-paint activation device coupled to the electronic-brush housing, an electronic-brush scanner coupled to the electronic-brush housing, and a controller in electrical communication with the electronic-paint device and the electronic-brush scanner. A position of the electronic brush is determined based on a registration code embedded in a portion of an image written on a portion of an electronic paint that is scanned by the electronic-brush scanner and communicated to the controller. An electronic-paint write signal is sent from the controller to the electronic-paint activation device based on the determined electronic-brush position.

The aforementioned and other features and advantages of the invention will become further apparent from the following detailed description of the presently preferred embodiments, read in conjunction with the accompanying drawings. The detailed description and drawings are merely illustrative of the invention rather than limiting, the scope of the invention being defined by the appended claims and equivalents thereof.

Various embodiment of the present invention are illustrated by the accompanying figures, wherein:

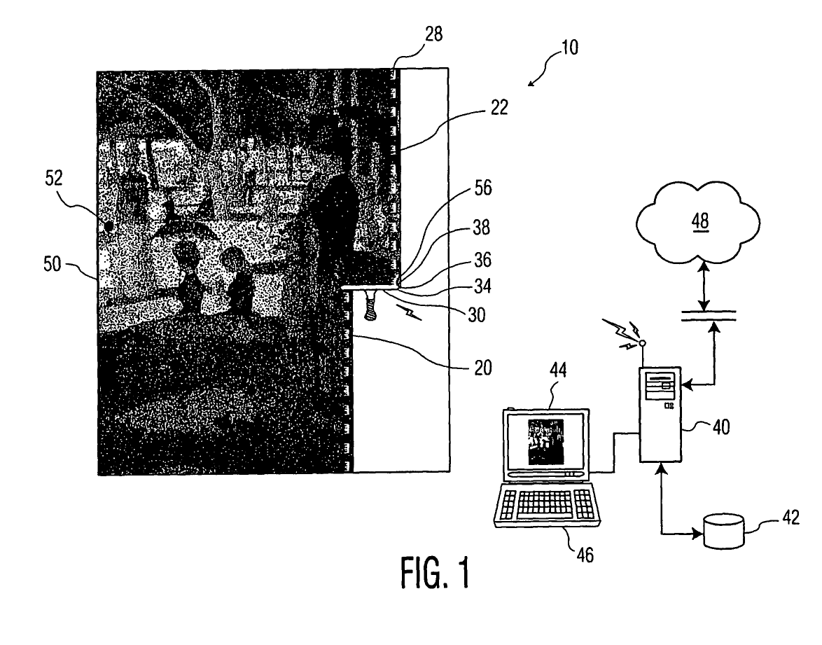

FIG. 1 is an illustration of a system for activating an electronic paint, in accordance with one embodiment of the current invention;

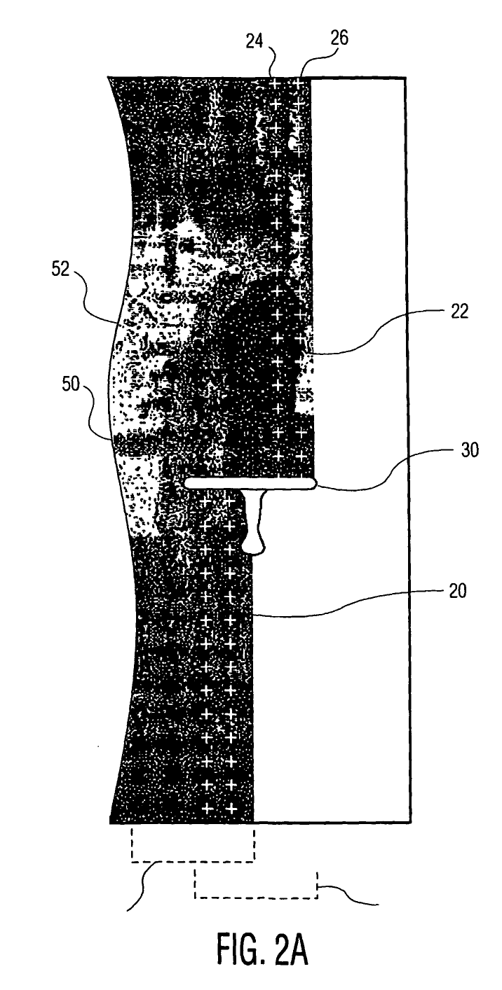

FIG. 2a is an illustration of a system for activating an electronic paint, in accordance with another embodiment of the current invention;

FIG. 2b is an illustration of a system for activating an electronic paint, in accordance with another embodiment of the current invention;

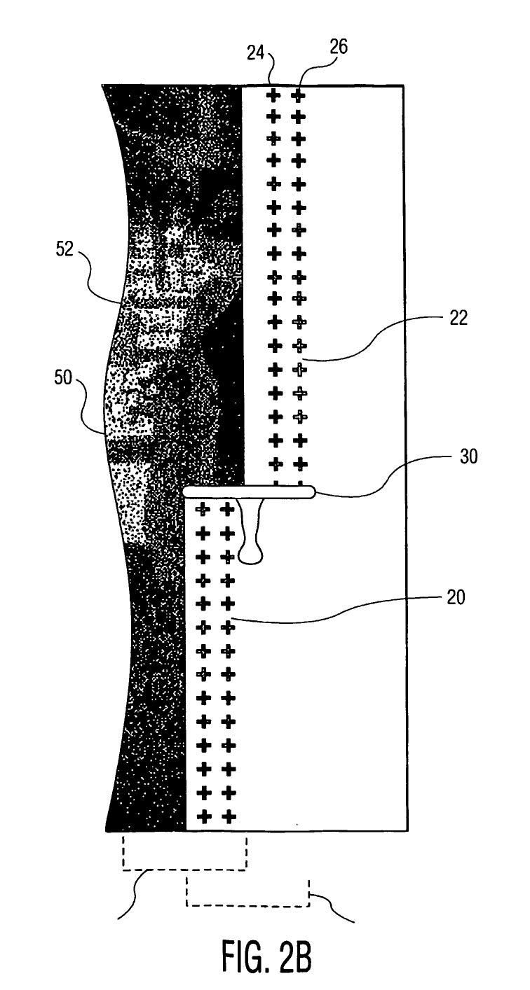

FIG. 3 is an illustration of an electronic brush, in accordance with one embodiment of the current invention;

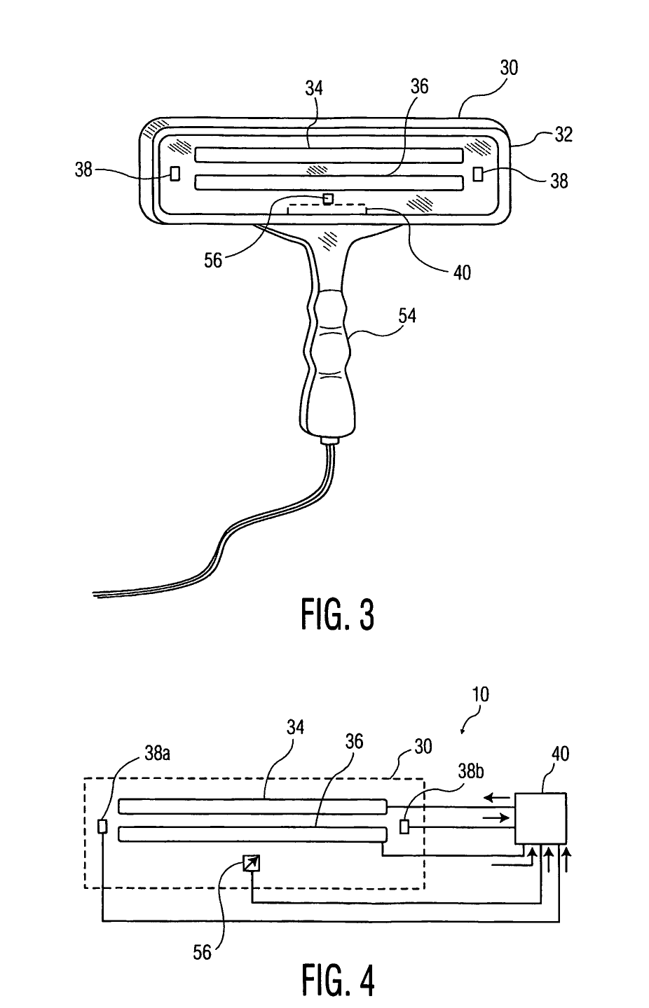

FIG. 4 is a block diagram of a system for activating an electronic paint, in accordance with one embodiment of the current invention; and

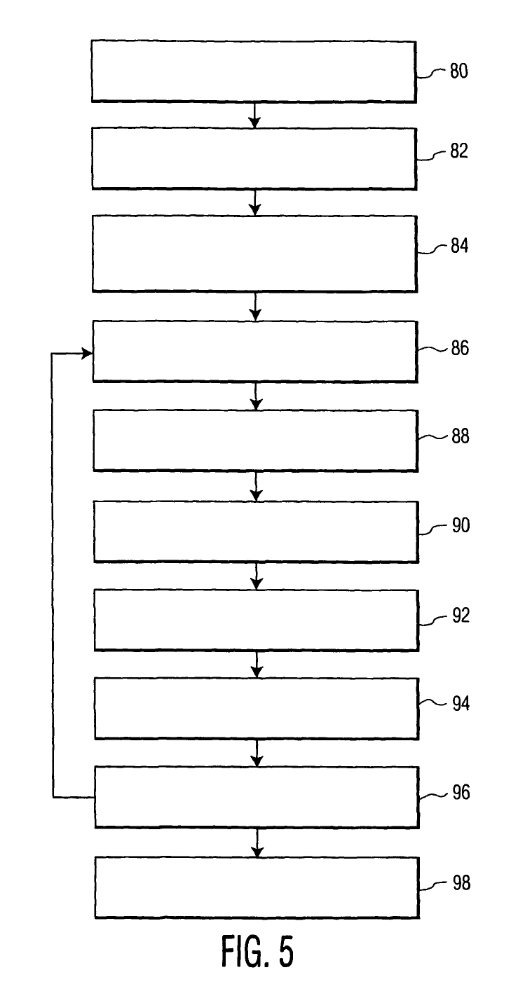

FIG. 5 is a flow diagram of a method for activating an electronic paint, in accordance with one embodiment of the current invention.

FIG. 1 illustrates a system for activating an electronic paint, in accordance with one embodiment of the present invention. Electronic-paint activation system 10 includes an electronic brush 30 with an electronic-paint activation device 34; an electronic-brush scanner 36 coupled to electronic brush 30; and a controller 40 electrically coupled to electronic-paint activation device 34 and electronic-brush scanner 36. Controller 40 may be wired or wirelessly connected to electronic-paint activation device 34 and electronic-brush scanner 36. Registration codes embedded in portions of a written image allow robust position detection for a multi-stroke electronic-brush display and provide for proper stitching between adjacent image portions, particularly when individual pixels or elements in the electrophoretic display can be addressed only once after resetting the display.

A first portion 20 of a predetermined image, which is written onto a portion of an electronic paint 50 on an electronic-paint surface 52 during a previous stroke, is scanned with electronic-brush scanner 36. Signals from electronic-brush scanner 36 are communicated to controller 40 and analyzed to detect electronic-paint registration codes embedded in the partially written image. First portion 20 of the predetermined image includes an embedded electronic-paint registration code such as a registration mark, a grid, or an electronic-paint surface coordinate 28 encoded as a barcode or a UPC code to allow a position or location of electronic brush 30 to be determined. An electronic-paint write signal is sent from controller 40 to electronic-paint activation device 34 based on the electronic-brush position. Though depicted on a wall and serving as an electronic wallpaper, electronic-paint surface 52 comprising electronic paint 50 may alternatively be on a desk, table, floor, ceiling, billboard, whiteboard, or other suitable surface.

As electronic brush 30 is stroked or passed over portions of electronic paint 50, a portion of a predetermined image is written on electronic paint 50. The predetermined image, comprising text, graphics, pictures, or combinations thereof, is written onto electronic paint 50 with electronic-ink or electronic-paint writing processes developed for electrophoretic displays, optically addressed electronic ink, and other types of electronic displays containing electronic ink or paint. As electronic brush 30 is passed multiple times over electronic-paint surface 52, electronic-paint surface coordinates 28 are detected and analyzed to determine an electronic-brush location so that the predetermined image can be written without gaps, waviness, or image shifts. Compensation for rotations and current locations of electronic brush 30 are made and updated image information is sent to electronic-paint activation device 34 for writing onto electronic paint 50 as electronic brush 30 is swept across electronic-paint surface 52. A second portion 22 of the predetermined image is written on electronic paint 50 during the current stroke based on the determined position of electronic brush 30. As second portion 22 of the predetermined image is written, a portion of the predetermined image is selectively written over the embedded registration code in first portion 20. A new registration code may be written on an uncoded surface portion of the electronic paint 50 while writing the second portion 22, wherein the new registration code is embedded in the second portion 22 of the predetermined image. The last stroke of electronic brush 30 across electronic-paint surface 52 for a multi-stroke image does not need to write an embedded registration code.

An exemplary electronic brush 30, which has a relatively flat, elongated surface area in the shape of a strip or bar, passes over portions of electronic paint 50 to address and activate electronic paint 50. As electronic brush 30 is moved or swept across electronic paint 50, an image including text, drawings, pictures or combinations thereof, is transferred or written onto electronic paint 50. To activate or write onto electronic paint 50, an activation voltage may be applied across the electrophoretic display, then portions of electronic paint 50 are addressed, for example, with electronic-paint activation device 34. Electronic paint 50 is addressed by determining an electronic-brush location and writing the intended image at a correct position on electronic-paint surface 52 based on that location determination. The image may be frozen, for example, by removing the activation voltage from across the electronic paint or ink after the electronic paint has been written on.

When small rotations of electronic brush 30 occur during brush sweeps across electronic paint 50, the result would be excessive waviness and aberrations of the intended image being transferred onto electronic paint 50 if no compensation were given for rotation. Compensation of electronic-brush rotations may be determined in part by, for example, reading two or more electronic-paint surface coordinates 28 spaced apart on electronic paint 50 and determining measurements of the electronic-brush rotations with respect to those electronic-paint surface coordinates 28. A determination of electronic-brush rotation can be made as electronic brush 30 is passed over electronic paint 50, and used to compensate for electronic-brush rotations while the intended image is being written. In one embodiment, a tilt sensor 56 attached to electronic brush 30 provides tilt signals to controller 40 to determine an electronic-brush rotation.

Data, pixel and address information may be transferred to and stored within electronic brush 30 and then an image can be written onto electronic paint 50 under the control of on-board controller 40. Alternatively, an external controller 40 such as a personal computer, a laptop computer, a personal digital assistant, a modified cell phone, a wireless device or a digital computing device can be used to store pixel and address information related to electronic paint 50. Controller 40, which may be wired or wirelessly connected to electronic brush 30, can contain the intended image within a database or a memory 42 such as a memory card or a memory stick. Selection and manipulations of the intended image prior to writing onto electronic paint 50 may be made, for example, with the help of computer software and hardware such as a display 44 and an input device 46 like a keyboard or a mouse. Controller 40 may have an Internet or web connection 48 to generate, select or receive image information.

To allow for continued registration and accurate writing onto electronic paint 50, new electronic-paint registration codes such as electronic-paint surface coordinates 28 may be written onto an uncoded second portion 22 of the predetermined image while writing a second portion 22 of the image on electronic paint 50. In another embodiment, electronic paint 50 has registration codes pre-written onto electronic paint 50, with, for example, fine or faint marks such that the registration codes can be read yet have minimal impact on the quality of the written image.

In some embodiments of the present invention, accurate writing of the codes is particularly critical during the first stroke of electronic brush 30 across electronic-paint surface 52 in order for the location and rotation of electronic brush 30 to be determined accurately during subsequent strokes. One or more position detectors 38 may be attached to electronic brush 30 to help determine the position of electronic brush 30 during the first scan and in subsequent scans or strokes of electronic brush 30. For example, a mechanical position detector 38 such as a wheel, trackball or a set thereof may be coupled to electronic brush 30. More specifically, a set of wheels or trackballs can provide position signals from which an electronic-brush rotation or an electronic-brush location can be determined. In another example, one or more optical position detectors 38, such as those used in an optical mouse for a computer, may be coupled to electronic brush 30. Position detectors 38 are in electrical communication with controller 40 to provide an electronic-brush position signal to controller 40 based on a movement of electronic brush 30. FIG. 2a shows details of a system for activating an electronic paint, in accordance with another embodiment of the current invention. In this depiction, a left side of electronic brush 30 detects registration codes on first portion 20 of the predetermined image on electronic paint 50. As electronic brush 30 is swept in a downward direction, electronic paint 50 on first portion 20 of the predetermined image is activated, selectively writing a portion of the predetermined image over the embedded registration codes. While writing a portion of the predetermined image on electronic paint 50, new electronic-paint registration codes are written on uncoded second portion 22 of the predetermined image on electronic paint 50.

In simplest form, registration codes can take the form of registration marks 24 such as cross hairs embedded in the image. Other types of registration codes such as an array of registration marks or a grid 26 may be written and subsequently read to determine the position of electronic brush 30. In cases where electronic brush 30 is lifted or removed from electronic-paint surface 52 and location information for electronic brush 30 might be lost or interrupted, an electronic-paint surface coordinate 28 such as numbered coordinates, a barcode, UPC coded numbers, or other suitable surface-location information and identification can be written onto electronic paint 50. In one embodiment, registration codes with electronic-paint surface coordinate information are pre-written into electronic paint 50. The pre-written registration codes may be overwritten with the predetermined image or retained for subsequent refreshing or updating of the image. Registration codes with embedded electronic-paint surface coordinates 28 allow more freedom of movement during multiple passes of electronic brush 30 over electronic-paint surface 52.

FIG. 2b illustrates a system for activating an electronic paint, in accordance with another embodiment of the present invention. Similar to FIG. 2a, a left side of electronic brush 30 detects registration codes on first portion 20 of the predetermined image on electronic paint 50. As electronic brush 30 is swept in a downward direction, electronic paint 50 on first portion 20 of the predetermined image is activated, selectively writing a portion of the predetermined image over the embedded registration codes. While writing a portion of the predetermined image on electronic paint 50, new electronic-paint registration codes are written on uncoded second portion 22 of the predetermined image on electronic-paint surface 52. In this depiction, registration codes such as registration marks 24, a grid 26, or electronic-paint surface coordinates 28 are written using pixel and intensity information corresponding to the region for the registration codes, the pixel information being adapted from the predetermined image being written. In other embodiments, an initially dark or black background is used with reversed or adapted registration codes placed accordingly.

FIG. 3 illustrates an electronic brush, in accordance with one embodiment of the present invention. Electronic brush 30 includes an electronic-brush housing 32 with an attached electronic-paint activation device 34 and an attached electronic-brush scanner 36. Controller 40 is electrically coupled to and in electrical communication with electronic-paint activation device 34 and electronic-brush scanner 36, and may be wired or wirelessly connected to electronic-paint activation device 34 and electronic-brush scanner 36. Electronic brush 30 may include a gripping handle 54 for ease in handling and manipulation. Electronic brush 30 may include a tilt sensor 56 electrically connected to controller 40 to determine electronic-brush rotations.

Electronic-brush scanner 36 includes, for example, a linear or a two-dimensional optical scanner that projects a focused beam of laser light onto an electronic paint to detect registration codes such as a registration mark, a grid, or an electronic-paint surface coordinate. A position of electronic brush 30 is determined based on signals from electronic-brush scanner 36 corresponding to registration codes embedded in a portion of the image written on the electronic paint. Electronic-brush scanner 36 provides signals when electronic brush 30 is stroked across an electronic-paint surface having an embedded registration code in a portion of the written image.

An electronic-paint write signal is sent from controller 40 to electronic-paint activation device 34 based on the electronic-brush position. Electronic-paint activation device 34 activates an electronic paint using, for example, a laser scanner that addresses a photoconductor within the electronic paint and switches the state of the electronic paint or ink by locally changing the conductivity of the photoconductor.

Electronic brush 30 may include controller 40 in electrical communication with electronic-paint activation device 34 and electronic-brush scanner 36. Controller 40, which may be located within electronic brush 30 or in a digital computing device operably coupled to electronic brush 30, includes application software and hardware used to determine the location and rotation of electronic brush 30 and to write the corresponding image onto the electronic paint. Electronic brush 30 may receive image information through a wired or wireless connection that couples electronic brush 30 to controller 40 when controller 40 is located external to electronic brush 30. The received image information may be stored, for example, within a memory stick or other suitable storage device within electronic brush 30.

A position detector 38 may be included with electronic brush 30 to aid in writing initial registration codes into the electronic paint, and to provide data on the location and rotation of electronic brush 30 to controller 40. One or more position detectors 38 such as wheels, trackballs, or optical mice may be coupled to electronic brush 30. Position detectors 38 provide an electronic-brush position signal to controller 40 based on movement of electronic brush 30. For example, a mechanical position detector 38 may include a set of wheels or trackballs at each end of electronic brush 30 that provide signals related to movement of electronic brush 30 from which the position and rotation of electronic brush 30 can be determined. In another example, an optical position detector 38 includes a set of optical mouse devices at each end of electronic brush 30 that provide signals from which the location and rotation of electronic brush 30 can be ascertained.

Electronic brush 30 may include a tilt sensor 56 attached to electronic-brush housing 32. Rotations of electronic brush 30 can be determined based on tilt signals from tilt sensor 56 received at controller 40. Tilt sensor 56 comprising, for example, a commercially available inclinometer, accelerometer, or bubble detection device, can determine an upward direction with respect to gravitational forces. Compensation for small rotations of electronic brush 30 can be made while electronic brush 30 is swept over an electronic-paint surface and image data is written.

FIG. 4 shows a block diagram of a system for activating an electronic paint, in accordance with another embodiment of the present invention. Electronic-paint activation system 10 includes an electronic brush 30 for writing a predetermined image on an electronic paint. The predetermined image may be written, for example, with an electronic-paint activation device 34 coupled to electronic brush 30. Writing the predetermined image onto the electronic paint is based on a determination of the position of electronic brush 30. The position of electronic brush 30 may be determined relative to the location of a coded portion of the electronic paint by scanning an electronic-paint registration code embedded in a predetermined image with, for example, a linear or two-dimensional electronic-brush scanner 36.

A new registration code such as a registration mark, a grid, or an electronic-paint surface coordinate may written on an uncoded surface portion of the electronic paint while writing a portion of the predetermined image on another part of the electronic paint. For example, the left half of electronic-paint activation device 34 can write a segment of the predetermined image on a coded portion or uncoded portion of the electronic paint underneath the left side of electronic brush 30,

while the right half of electronic-paint activation device 34 writes an adapted or embedded electronic-paint registration code on an uncoded portion of the electronic paint underneath the right side of electronic brush 30.

An electronic-brush position input may be received from, for example, one or more mechanical or optical position detectors 38a and 38b. A new electronic-paint registration code that is based on the electronic-brush position input may be embedded in the predetermined image and written on an uncoded surface portion of the electronic paint. For example, when electronic brush 30 is first passed over the electronic-paint surface, a portion of the intended image is written along with an embedded electronic-paint registration code. Subsequent passes of electronic brush 30 over the electronic-paint surface may be synchronized to additional electronic-brush position inputs or to scanned electronic-paint registration codes. When electronic brush 30 is returned to electronic-paint surface after a temporary removal from the electronic-paint surface, such as after the completion of a brush stroke, an electronic-paint surface coordinate may be scanned to determine the location of electronic brush 30. After verification of the scanned registration code, the writing of the electronic paint can continue.

The reading and analysis of two or more registration codes may determine electronic-brush rotations. Alternatively, small rotations of electronic brush 30 may be determined with a tilt sensor 56 attached to electronic brush 30. Tilt sensor 56 can determine an upward direction with respect to gravitational forces, and then data that is to be written onto the electronic paint while electronic brush 30 is swept over the electronic-paint surface is compensated accordingly. Tilt signals from tilt sensor 56 may be received at controller 40 to determine an electronic-brush rotation.

Controller 40, electrically coupled to electronic-paint activation device 34 and to electronic-brush scanner 36, receives input and sends write signals to electronic-paint activation device 34. Controller 40 may be internally mounted within electronic brush 30, or externally located, for example, in a digital computing device such as a personal computer, a laptop computer, a personal digital assistant, a modified cell phone, or a wireless device. Controller 40 may be wired or wirelessly connected to electronic-paint activation device 34 and electronic-brush scanner 36.

FIG. 5 shows a flow diagram of a method for activating an electronic paint, in accordance with one embodiment of the present invention. The electronic-paint activation method includes various steps to determine the position of an electronic brush and to write or activate the electronic paint based on the determination of the brush position.

In cases where the electrophoretic display requires resetting the electronic ink or electronic paint to an initial state, the electronic paint is initialized to a reset state, as seen at block 80. For example, the display may be reset to a state where the electronic paint is all white, and activation of the electronic paint with the electronic brush causes the electronic paint to locally become darker or to change towards another predefined color.

In other cases where activation of the electronic paint with the electronic brush makes the electronic paint whiter, the electronic paint can be reset to a state where the electronic paint is all black. It is possible for the electronic paint to be reset to other predetermined colors and states, depending on the electronic-paint technology. Assuming that the display allows various shades of gray and is initialized so that the electronic paint is all white, then activation of the electronic paint will turn portions of the electronic paint gray or black in accordance with the desired image. After the reset operation, the previous image on the display is effectively erased.

Based on the predetermined image and details of the electrophoretic ink, the preferred locations on the electronic-paint surface and the type and intensity of the registration codes may be determined. For example, a determination may be made that a black background or a white background be initialized based on the image to be written. In another example, the location and density of registration codes or markers within the image to be written are determined. In another example, a determination is made whether to write the registration codes by leaving the markers in the same state as the background or to write them at the desired locations with pixel and intensity information from the predetermined image. In cases where the image does not support a particular registration code type, modifications may be made to the generated image, such as increasing the background level in the region of the registration markers to exceed the minimum threshold requirements of the scanner or determining how many markers are needed in the area that is below the detection threshold.

An electronic-brush position input is received, as seen at block 82. The electronic-brush position input may be received, for example, from a mechanical position detector or an optical position detector. In some cases there may be no registration codes in the electronic paint when the electronic brush is scanned across the surface of the electronic paint for the first time. Until registration codes can be written in the electronic paint, input signals from one or more position detectors on the electronic brush provide electronic-brush position signals from which the position and rotation of the electronic brush are determined.

During the first pass of the electronic brush across the surface of the electronic paint, an electronic-paint registration code may be written on an uncoded surface portion of the electronic paint while writing a portion of the predetermined image, as seen at block 84. An adapted electronic-paint registration code is written on an uncoded portion of the electronic paint with image data based on the electronic-brush position input. The adapted electronic-paint registration code can be adapted and chosen so that the code does not interfere with image information. For example, when the image is darker in an overlap region, pixels may be selectively omitted to form a recognizable registration code within the image. In cases where the image is lighter in the overlap region, faint registration codes may be selectively embedded so that they have an intensity above a detection threshold of the electronic-brush scanner and can be detected by the electronic-brush scanner. In portions where the image is very light, faint registration codes such as dots may be written into the overlap regions and retained there, resulting in minimal aberrations to the image. In a similar manner, the background of the image may be raised in intensity just enough to allow the codes to be written, resulting in a small reduction in the contrast ratio of the written image. In yet other examples, the electrophoretic display can be reset to a completely black or dark configuration prior to writing portions of the image and the embedded codes; or a thin borderline may be written around the picture to act as a well-defined starting point. Pixel groups may be detected when the registration code differs from the reference background by at least a predetermined number of gray levels, set in part by the detection limits of the electronic-brush scanner. Registration codes may include, for example, a simple sequence of bars or more complex codes such as numbered coordinates, barcodes, UPC coded numbers, or other suitable surface-location indicia that are embedded into an electronic-paint image. In another embodiment, position inputs from position detectors within the electronic brush such as wheels with rotation sensors are used for electronic-brush position determination, including location and rotation. In yet another embodiment, driven wheels with force feedback coupled to the electronic brush are controlled to retain the brush in a straight line and to control the position of the brush.

In most of the aforementioned embodiments of the present invention, embedded electronic-paint registration codes are written in the overlap region between two strokes of the electronic brush. By selectively skipping the writing of pixels in overlap portions of the image, position information may be embedded within the image and written over on a subsequent stroke of the electronic brush. In embodiments where the registration codes are predisposed on the electronic paint, for example, with indelible ink applied at the time of manufacture, the position detectors are not required and new registration codes do not need to be written.

After writing the desired image and registration codes onto the electronic paint and completing the first stroke, the electronic brush may be moved and repositioned to perform additional strokes across the electronic-paint surface.

An electronic-paint registration code is scanned, as seen at block 86. The electronic brush reads the registration codes to provide accurate writing of the predetermined image and minimize distortion, particularly in overlap regions. The electronic-paint registration codes are embedded in a portion of an image written on a portion of the electronic paint. The electronic-paint registration codes may comprise, for example, a registration mark, a grid, or an electronic-paint surface coordinate. Scanning the registration codes allows a position of the electronic brush to be determined. For example, an embedded registration code embedded in a first portion of an image written on a portion of the electronic paint is scanned.

Electronic-brush rotations may be determined by, for example, reading two or more registration codes written onto the electronic paint. Alternatively, the electronic-brush rotation can be determined with tilt signals received from a tilt sensor attached to the electronic brush, as seen at block 88. Signals from the tilt sensor indicate the brush angle with respect to a gravitational vector, and can be processed by the controller to determine the electronic-brush rotation and to compensate the image data accordingly.

The position of the electronic brush is determined, as seen at block 90. For example, a controller in communication with the electronic brush output analyzes embedded registration code data from the electronic-brush scanner so that the position of the embedded registration codes can be determined. When the positions of the registration codes are determined, the position of the electronic brush relative to the coded portion of the electronic paint with the embedded registration codes can be determined, and the electronic paint can be written to accordingly. As additional portions of the image are written with subsequent overlapping passes of the electronic brush, accurate position information is necessary to provide proper stitching between adjacent portions of the image.

Rotations of the electronic brush, with respect to the surface of the electronic paint as the electronic brush is brushed across the electronic-paint surface, require compensation for writing smooth, non-distorted images onto the electronic paint. Electronic-brush rotations may be determined from tilt signals received from a tilt sensor attached to the electronic brush. Alternatively, an electronic-brush rotation can be determined based on the electronic-paint registration codes. The electronic-brush rotation may be determined, for example, by scanning and reading two registration marks or by inspecting a registration grid.

The location of the electronic brush is determined, for example, by scanning and reading electronic-paint surface coordinates written on the electronic paint. With coordinates such as x and y distances from a fixed reference point such as the lower left corner of the electronic-paint surface, the electronic brush can be removed and returned to the electronic-paint surface where the system is able to determine the electronic-brush location again by reading the coordinates.

An additional portion of the predetermined image is written on the electronic paint based on the determined position of the electronic brush, as seen at block 92. The

predetermined image including text, graphics or pictures is written, for example, with an electronic-paint activation device attached to the electronic brush. The electronic-paint activation device switches the electronic ink or paint from white to black, from black to white, or to a desired color depending on the type of electronic ink or paint used. Once the electronic paint has been switched, the electronic brush can be moved or removed, and the image is retained by the electronic paint. In some embodiments of the present invention, writing an additional portion of the predetermined image on the electronic paint comprises selectively writing a portion of the image over the embedded registration codes of a previously written portion, once the embedded registration codes have been read and the position of the electronic brush determined.

As the electronic paint is written with at least a portion of the predetermined image on a portion of the electronic paint, new electronic-paint registration codes that are embedded in the image may be written, as seen at block 94. The new electronic-paint registration code comprises, for example, a registration mark, a grid, or an electronic-paint surface coordinate. For example, the new registration code is written on an uncoded second portion of the electronic paint such as the overlap region while writing the second portion of the image with an embedded registration code. For example, a left portion of the electronic-paint activation device is sent data associated with the predetermined image, while the right portion of the electronic-paint activation device is sent data associated with the new registration codes. With the next sweep of the brush, the new electronic-paint registration codes are scanned and used to determine the position of the electronic brush so that additional portions of the predetermined image can be accurately written in the electronic paint.

As the first pass and subsequent strokes of the electronic brush are completed and portions of the predetermined image are written, the electronic brush is removed and returned to the electronic-paint surface where electronic-paint registration codes are scanned, as seen at block 96. While the electronic brush is moved across the electronic paint, the location and angle of the electronic brush is monitored and updated so that image information can be appropriately addressed and written onto the electronic paint. Steps indicated at block 86 and following are repeated until the entire image is written onto the electronic paint. For larger images, the electronic brush may be passed multiple times across the electronic paint to construct a complete picture. Accurate determination of the electronic brush location and rotation reduces alignment artifacts that can be caused by multiple strokes of the brush.

After all strokes of the brush have been completed and the image generation is finished, the electronic brush may be removed from the wall or surface until the image requires updating or a refreshed image is desired, as seen at block 98.

While the embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

In interpreting the appended claims, it should be understood that:
a) the word “comprising” does not exclude the presence of other elements or acts than those listed in a given claim:
b) the word “a” or “an” precediang an element does not exclude the presence of a plurality of such elements;
c) any reference numerals in the claims are for illustration purposes onl and do not limit their protective scope;
d) several “means” may be represented by the same item or hardware or software implemented structure or function; and
   each of the disclosed elements may be comprised of hardware portions (e.g., discrete electronic circuitry), software portions (e.g., computer programming), or any combination thereof.

1. A method of activating an electronic paint (50), comprising:
scanning a registration code embedded in a first portion (20) of an image written on a portion of an electronic paint (50);
determining a position of an electronic brush (30) based on the scanned registration code; and
writing a second portion (22) of the image on the electronic paint (50) based on the determined position of the electronic brush (30).

2. The method of claim 1 wherein writing the second portion (22) of the image on the electronic paint (50) comprises selectively writing a portion of the image over the embedded registration code.

3. The method of claim 1 further comprising:
writing a new registration code on an uncoded second portion (22) of the electronic paint (50) while writing the second portion (22) of the image, wherein the new registration code is embedded in the second portion (22) of the image.

4. The method of claim 3 wherein writing the new registration code comprises writing one of a registration mark (24), a grid (26), or an electronic-paint surface coordinate (28).

5. The method of claim 1 further comprising:
receiving an electronic-brush position input; and
writing an adapted registration code on an uncoded surface portion (22) of the electronic paint (50) based on the electronic-brush position input.

6. The method of claim 5 wherein the electronic-brush position input is received from one of a mechanical position detector (38) or an optical position detector (38).

7. The method of claim 1 further comprising:
receiving a tilt signal from a tilt sensor (56) attached to the electronic brush (30); and
determining a rotation of the electronic brush (30) based on the received tilt signal.

8. The method of claim 1 further comprising:
initializing the electronic paint (50) to a reset state.

9. The method of claim 8 wherein the initialized electronic paint (50) is reset to a predetermined color.

10. A system for activating an electronic paint (50), comprising:
an electronic brush (30) including an electronic-paint activation device (34);
an electronic-brush scanner (36) coupled to the electronic brush (30); and
a controller (40) in electrical communication with the electronic-paint activation device (34) and the electronic-brush scanner (36), wherein a position of the electronic brush (30) is determined based on a registration code embedded in a first portion (20) of an image written on a portion of an electronic paint (50) that is scanned by the electronic-brush scanner (36) and communicated to the controller (40), and wherein an electronic-paint write signal is sent from the controller (40) to the electronic-paint activation device (34) based on the determined electronic-brush position.

11. The system of claim 10 wherein the embedded registration code comprises one of a registration mark (24), a grid (26), or an electronic-paint surface coordinate (28).

12. The system of claim 10 further comprising:
a position detector (38) coupled to the electronic brush (30) and in electrical communication with the controller (40), wherein the position detector (38) provides an electronic-brush position signal to the controller (40) based on a movement of the electronic brush (30).

13. The system of claim 12 wherein the position detector (38) comprises at least one of a mechanical position detector (38) or an optical position detector (38).

14. The system of claim 10 wherein the electronic-paint activation device (34) and the electronic-brush scanner (36) are wired or wirelessly connected to the controller (40).

15. The system of claim 10 further comprising:
a tilt sensor (56) attached to the electronic brush (30), wherein a tilt signal from the tilt sensor (56) is received at the controller (40) to determine an electronic-brush rotation.

16. An electronic brush (30) for activating an electronic paint (50), comprising:
an electronic-brush housing (32);
an electronic-paint activation device (34) coupled to the electronic-brush housing (32);
an electronic-brush scanner (36) coupled to the electronic-brush housing (32); and
a controller (40) in electrical communication with the electronic-paint activation device (34) and the electronic-brush scanner (36), wherein a position of the electronic brush (30) is determined based on a registration code embedded in a portion of an image written on a portion of an electronic paint (50) that is scanned by the electronic-brush scanner (36) and communicated to the controller (40), and wherein an electronic-paint write signal is sent from the controller (40) to the electronic-paint activation device (34) based on the determined electronic-brush position.

17. The electronic brush (30) of claim 16 wherein the controller (40) is wired or wirelessly connected to the electronic-paint activation device (34) and the electronic-brush scanner (36).

18. The electronic brush (30) of claim 16 further comprising:
a position detector (38) coupled to the electronic brush (30) and in electrical communication with the controller (40), wherein the position detector (38) provides an electronic-brush position signal to the controller (40) based on a movement of the electronic brush (30).

19. The electronic brush (30) of claim 18 wherein the position detector (38) comprises at least one of a mechanical position detector (38) or an optical position detector (38).

20. The electronic brush (30) of claim 16 further comprising:
a tilt sensor (56) attached to the electronic brush (30) and in electrical communication with the controller (40), wherein a tilt signal from the tilt sensor (56) allows a determination of an electronic-brush rotation
